(19) United States
(12) Patent Application Publication
(10) Pub. No.: US 2015/0238038 A1
(43) Pub. Date: Aug. 27, 2015

(54) Single Serve Brew Enhancer

(71) Applicants: Alan Craig Brinson, Edgewood, NM (US); Arthur G. Padilla, Edgewood, NM (US)

(72) Inventors: Alan Craig Brinson, Edgewood, NM (US); Arthur G. Padilla, Edgewood, NM (US)

(21) Appl. No.: 14/187,656

(22) Filed: Feb. 24, 2014

(51) Int. Cl. A47J 31/40

(52) U.S. Cl. CPC A47J 31/407

(57) ABSTRACT

The SINGLE SERVE BREW ENHANCER is comprised of two structural parts, a small perforated grounds disc and its accompanying basket that are designed to slow the flow of water through a single serve “home brew pod” (“My K-Cup”™) used with single serve automatic coffee makers. This both extends steeping time and allows for a richer flavor of coffee to be brewed.

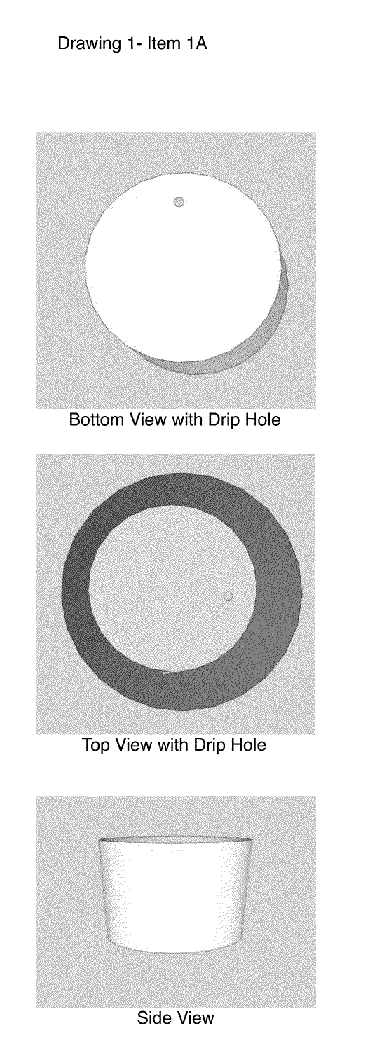

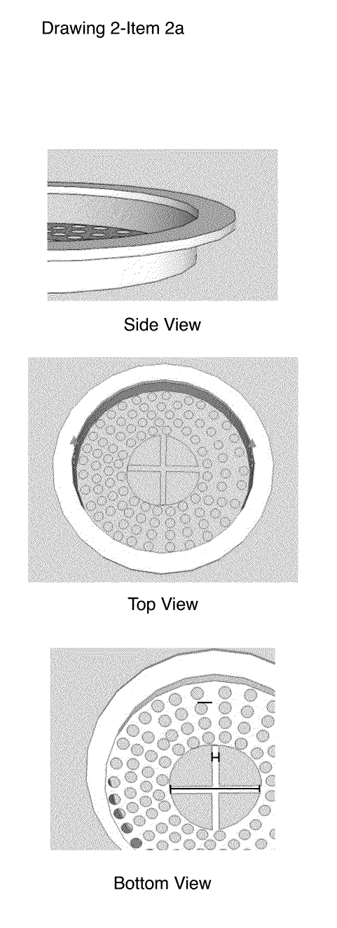

### BACKGROUND OF THE INVENTION

The present invention relates to individual serve coffee/tea brewing and/or steeping of coffee grounds and more specifically it relates to reducing the water flow time allowing the coffee to steep longer and to develop a fuller flavor while also eliminating the current problem of pressure build up in the pre-manufactured individual K-cup™ style sealed pods.¹ ¹ Beth, M. (2011). Exploding k-cup. Barista. Retrieved from http://www.kcupbarista.com/2011/06/exploding-k-cups/

### Description of the Prior Art:

Single serve K-cup™ style machines have been in use for several years. Typically, a manufacturer will supply a My K-cup™ style single serve device for the user to make their own coffee brews at home using their own grounds, versus purchasing the manufactured pre-sealed prefilled pods. The user then uses a manufacturer furnished scoop to fill the mesh filter with the substance of choice, i.e. coffee grounds or tea leaves of choice. At this point the mesh filter with the users substance of choice is placed into the automatic brewing machine the lid is closed and the brew process is initiated.

The main problem with this brewing process is that the water is injected and allowed to flow through and past the grounds or leaves too quickly making a less robust, weaker flavored beverage. Additionally, there have been documented problems with the pre-sealed K-cup™ style pods building up too much pressure causing the enclosed grounds or other substance, which is very hot, to be ejected forcefully posing a safety concern and increasing the risk for burn.¹

### BRIEF SUMMARY OF THE INVENTION

The SINGLE SERVE BREW ENHANCER is comprised of two structural parts designed to enhance the efficacy of the “home brew pod,” or My K-cup™ generally equipped with the single serve brew machines. This is achieved by slowing the flow of water thus extending steeping time and producing a richer flavor of coffee

### BRIEF DESCRIPTION OF THE SEVERAL VIEWS OF THE DRAWING

Part 1a (see attached drawings) is the filter reservoir which is an open topped, solid basket made of food grade plastics or food grade metals, with a single hole (a) located on the bottom of the basket measuring 1/16″ (a) diameter and located ¼″ (a) from the basket side wall. The basket whether made from the plastic or metal option should meet the following dimensions for correct placement and operation with single serve automatic drips coffee makers: 1.5″ in height (b), with a top diameter of 1.75″ (c) tapering to a bottom diameter of 1.25″ (d), with an overall container wall thickness of 1 mm (e) (see Drawing 1).

Part 2a (see attached drawing) is a perforated circular “grounds disc” with the following dimensions working from the outside in: The “grounds disc” is 1 7/16″ (a) in diameter and 1/32″ (b) thick and is inset by a 2/32″ (c) rim before descending into 0.5″ (d) deep cup with the bottom having a ¼″ wide perforated band (e) of 98 evenly spaced 1/16″ (f) holes. Followed by a center hole of ½″ (g) diameter with a 1/16″(h) stamp/cut-out, perpendicular crossbar (see Drawing 2).

### DETAILED DESCRIPTION OF THE INVENTION

### Brief Description:

The SINGLE SERVE BREW ENHANCER is comprised of two structural parts that allow the flow of water through a single serve automatic coffee maker to be slowed to extend steeping time and allow for a richer flavor of coffee to be brewed through the “home brew pod” (“My K-Cup”™) generally equipped with single serve brew machines.

### Manner and Process of Using:

The SINGLE SERVE BREW ENHANCER is designed to be used specifically with “K-cup,”™ style machines and the “My K-cup™,” reusable filter. The SINGLE SERVE BREW ENHANCER slows the steeping process of the water through the ground coffee beans in order to significantly enhance the richness and flavor of each cup brewed. The SINGLE SERVE BREW ENHANCER also allows adequate water flow through the “My K-Cup”™ to avoid a pressure build up in the automatic coffee maker in use. Lastly, the SINGLE SERVE BREW ENHANCER also addresses the problem/safety issue involved in the pressure build up in the sealed manufactured “K-cup”™ style coffee and flavored drink pods.¹

### Specific Embodiment of the Process (Including Mode of Operation):

i) Item 1a. Semi-Permanent Basket (see Drawing 1).

ii) Item 2a. perforated disc filter (see Drawing 2).

iii) The process of using the SINGLE SERVE BREW ENHANCER is:
(1) Place the semi permanent basket portion into the coffee machine manufacturer included home brew pod chamber of the “My K-Cup”™.
(2) Use the coffee machine manufacturer included “My K-Cup”™. mesh filter and fill with 1 Tbsp. coffee grounds (approximately ½ of the supplied 2 Tbsp grounds measuring spoon)
(3) Place the perforated disc filter 2a. on top of the grounds
(4) Place the remaining 1 Tbsp. of coffee grounds on top of the perforated disc filter 2a.
(5) The filled mesh filter is then placed into the coffee machine manufacturer included “My K-Cup”™. filter holder
(6) Followed by the coffee machine manufacturer included “My K-Cup”™. lid being securely tightened
(7) Manufacturer directions are to be followed from this point forward for optimal performance and efficacy.

We claim:

1. The SINGLE SERVE BREW ENHANCER reduces the flow of water through the coffee grounds or tea leaves, thus enhancing the flavor. A Single Serve Brew Enhancer comprising:
A filter reservoir that tapers from top to a more narrow bottom with a small hole in the bottom piece of the reservoir to allow the finished beverage product to drip through to a holding container.
A perforated grounds disc which is placed in the center portion of the brew solids in order to extend exposure of water for enhanced infusion.
The direct center of the bottom portion of the perforated grounds disc has a center hole with a perpendicular cross bar cut out/stamp out to compensate for pressure build-up.
